(19) United States
(12) Patent Application Publication
(10) Pub. No.: US 2006/0256023 A1
(43) Pub. Date: Nov. 16, 2006

(54) Neck-hanging type antenna

(75) Inventors: Shing-Yeu Juang, Taoyuan Hsien (TW); Wei-Ting Chen, Taoyuan Hsien (TW)

Correspondence Address: BACON & THOMAS, PLLC, 625 SLATERS LANE, FOURTH FLOOR, ALEXANDRIA, VA, 22314, US

(73) Assignee: PRIME ELECTRONICS AND SATELLITICS INCORPORATION, TAOYUAN HSIEN (TW)

(21) Appl. No.: 11/202,241

(22) Filed: Aug. 12, 2005

(30) Foreign Application Priority Data
May 10, 2005 (TW) 94207512

(51) Int. Cl. H01Q 1/12

(52) U.S. Cl. 343/718

(57) ABSTRACT

A neck-hanging type antenna includes an elongated body formed of a flexible material, and an electrically conductive member formed of a flexible circuit board. The elongated body has an axially extended receiving space in which the electrically conductive member is mounted for receiving magnetic waves.

### BACKGROUND OF THE INVENTION

1. Field of the Invention

The present invention relates to an antenna and more particularly, to a neck-hanging type antenna.

2. Description of the Related Art

A home TV may be equipped with a digital signal receiver, which is so-called Set Top Box, for receiving digital TV signal. A computer can also be equipped with a digital TV receiver for receiving digital TV signal. A digital TV receiver has a USB (Universal Serial Bus) connector for connection to a USB port at a computer. When using a digital TV receiver, a coaxial cable is used to connect the digital TV receiver to an indoor antenna, for enabling the digital TV receiver to receive digital TV signal through the indoor antenna for output of digital TV signal through the display monitor of the computer. Following the market trend for electronic products having lighter, thinner, shorter and smaller characteristics, commercial digital TV receivers are miniaturized for convenient carrying with a mobile computer to any place where digital TV signal is receivable.

However, a digital TV receiver must be used with an indoor antenna to receive digital TV signal. Commercial indoor antennas commonly have a big dimension, not convenient to carry.

### SUMMARY OF THE INVENTION

The present invention has been accomplished under the circumstances in view. It is the main object of the present invention to provide a neck-hanging type antenna, which is convenient to use and to carry.

To achieve this object of the present invention, the neck-hanging type antenna comprises an elongated body formed of a flexible material, for example, a woven fabric rope, and an electrically conductive member formed of a flexible material, for example, a flexible circuit board. The electrically conductive member is axially mounted to the elongated body for receiving magnetic waves.

In a preferred embodiment of the present invention, the elongated body has an axially extended inside receiving space in which the electrically conductive member is mounted. In addition, the neck-hanging type antenna further comprises a connector, which is electrically connected to the electrically conductive member and joined with two distal ends of the elongated body to define the elongated body a loop shape.

### BRIEF DESCRIPTION OF THE DRAWINGS

FIG. 1 is a schematic drawing of a preferred embodiment of the present invention.

FIG. 2 is a sectional view in an enlarged scale taken along line 2-2 of FIG. 1.

### DETAILED DESCRIPTION OF THE INVENTION

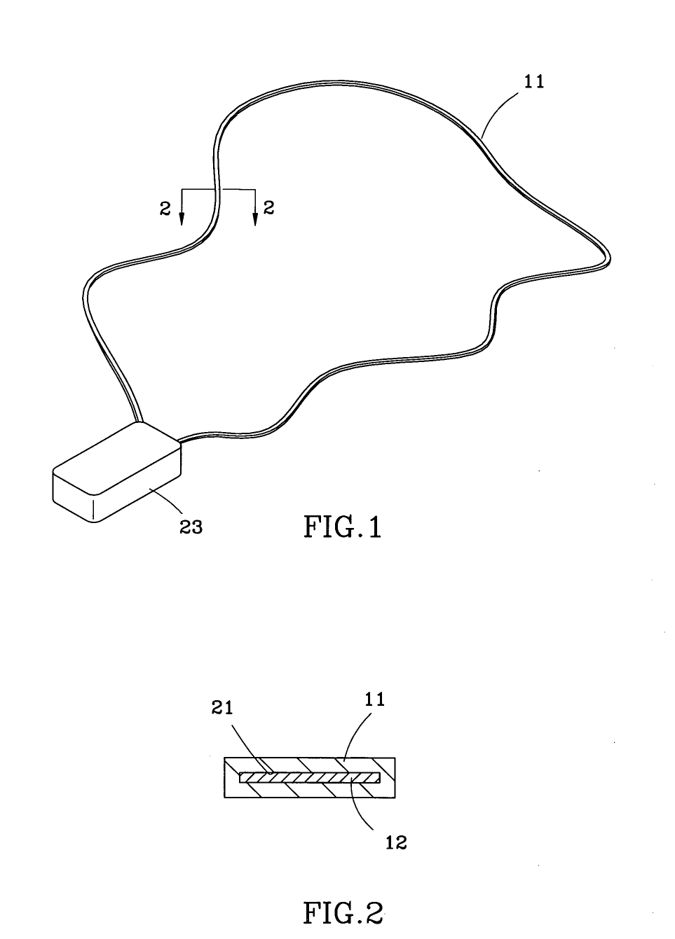

Referring to FIGS. 1 and 2, a neck-hanging type antenna in accordance with the present invention is shown comprising a body 11 and an electrically conductive member 12. The body 11 is an elongated rope of soft woven material defining an axially extending receiving space 21. Further, a connector 23 joins the two ends of the body 11, holding the body 11 in the shape of a loop.

The electrically conductive member 12 is formed of an elongated flexible circuit board having circuits therein (not shown). The electrically conductive member 12 is mounted in the receiving space 21 inside the body 11 and electrically connected to the connector 23. The electrically conductive member 12 is adapted to receive magnetic waves, to convert received magnetic waves into a current signal, and to transmit the current signal to the connector 23.

Because the body 11 is a woven rope surrounding the electrically conductive member 12 that is formed of a flexible circuit board, the assembly that is formed of the body 11 and the electrically conductive member 12 is highly bendable to change the shape. When in use, the user can connect the connector 23 to a digital TV receiver, allowing the digital TV receiver to receive digital TV signal through the electrically conductive member 12. When detached from the digital TV receiver, the body 11 of the neck-hanging type antenna can be hung on the user's neck

As indicated above, the body and the electrically conductive member are flexible; therefore the neck-hanging type antenna is easy to use and to carry.

What is claimed is:

1. A neck-hanging type antenna comprising:
a body formed of an elongated flexible material; and
an electrically conductive member formed of a flexible material and axially mounted to said body.

2. The neck-hanging type antenna as claimed in claim 1, wherein said body has an axially extended inside receiving space for accommodating said electrically conductive member.

3. The neck-hanging type antenna as claimed in claim 1, wherein said body is a woven fabric rope.

4. The neck-hanging type antenna as claimed in claim 1, wherein said electrically conductive member is a flexible circuit board.

5. The neck-hanging type antenna as claimed in claim 1, further comprising a connector that joins two distal ends of said body; wherein said connector is electrically connected to said electrically conductive member.
